(19) United States
(12) Patent Application Publication
(10) Pub. No.: US 2026/0158766 A1
(43) Pub. Date: Jun. 11, 2026

(54) Laminated Glass Pane With Year-Round Function, Controller, And Vehicle

(71) Applicant: Volkswagen Aktiengesellschaft, Wolfsburg (DE)

(72) Inventor: Roland Hacker, Wolfsburg (DE)

(73) Assignee: Volkswagen Aktiengesellschaft, Wolfsburg (DE)

(21) Appl. No.: 19/327,751

(22) Filed: Sep. 12, 2025

(30) Foreign Application Priority Data
Sep. 16, 2024 (DE) 10 2024 208 801.3

(51) Int. Cl. B32B 17/10; H05B 3/84

(52) U.S. Cl. CPC B32B 17/10201; B32B 17/10036; H05B 3/84; B32B 2255/205; B32B 2605/00

(57) ABSTRACT

The disclosure relates to a laminated glass pane, comprising an outer pane, an inner pane, and an intermediate plastics film which is arranged between the outer pane and the inner pane, further comprising: a reflective coating that is applied to a side of the outer pane that is facing the intermediate plastics layer, and a heating coating that is applied to a side of the inner pane that is facing the intermediate plastics layer, wherein the heating coating is designed to be supplied with electrical energy in order to heat the laminated glass pane.

### CROSS-REFERENCE TO RELATED APPLICATIONS

This application claims priority to German Patent Application No. DE 10 2024 208 801.3, filed on Sep. 16, 2024 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a laminated glass pane with year-round function that has both a sun protection and a heating function, as well as to a controller for the laminated glass pane and to a vehicle having the laminated glass pane.

Laminated glass panes (front windows) are known which regulate the heat input through a combination of a special glass design and coatings. Front windows are often manufactured from laminated glass consisting of two glass layers with an intermediate plastics film. This film generally has UV-absorbing properties and, together with the individual sheets of glass, prevents UV light from penetrating into the interior almost entirely. In addition, windscreens can be provided with infrared-reflecting coatings that deflect the thermal radiation of the sun primarily in the IR range of the radiation spectrum and, at the same time, the legally required minimum light transmission in the wavelength range that is visible to humans, i.e., between 380 nm and 780 nm, is adhered to. Thus, the interior heating caused by the incoming radiation is reduced.

Furthermore, it is known that front windows in vehicles are heated by a specially developed ventilation system that conducts (warm) air over the inside of the pane. The air conducted over the inside of the pane is provided by means of a supply of warm air from nozzles in the dashboard. This function is particularly useful in the cold months when frost or snow can obstruct the view. By circulating warm air, the front window is defrosted or kept free of condensation, which improves the visibility conditions or else makes it possible to see through the pane and thus increases the driving safety.

### SUMMARY

A need exists to provide an improved front window. The need is addressed by the subject matter of the independent claim(s). Embodiments of the invention are described in the dependent claims, the following description, and the drawings.

### BRIEF DESCRIPTION OF THE DRAWINGS

FIG. 1 shows a cross-section through a laminated glass pane according to one embodiment;

FIG. 2 shows a vehicle having a laminated glass pane according to one embodiment; and

FIG. 3 shows a vehicle having a laminated glass pane, a controller, and a power source according to one embodiment.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Some embodiments provide an improved laminated glass pane, for example as a front window for vehicles, that has optimum properties both in the summer and in the winter. Specifically, it may in some embodiments be a front window having a layer of silver on the inside of the outer sheet of glass and an ITO, ZNO:Al or FTO layer (indium tin oxide, aluminum-doped zinc oxide, or fluorine-doped tin oxide) on the outside of the inner sheet of glass. The benefits of both coatings can be utilized using this combination: The layer of silver reflects sunlight and thus reduces the heating of the vehicle interior in the summer, while the ITO/ZNO:Al/FTO layer allows for an efficient heating function in the winter. The heating capacity is significantly greater compared to previous solutions, allowing for faster and more efficient defrosting and defogging of the pane. In addition, the high operating voltage of the ITO/ZNO:Al/FTO layer requires a smaller cable cross-section.

In some embodiments, a laminated glass pane is provided that comprises an outer pane, an inner pane, and an intermediate plastics film which is arranged between the outer and inner pane, further comprising: a reflective coating that is applied to a side of the outer pane that is facing the intermediate plastics layer, and a heating coating that is applied to a side of the inner pane that is facing the intermediate plastics layer, wherein the heating coating is designed to be supplied with electrical energy in order to heat the laminated glass pane.

Laminated glass is a type of safety glass that is produced by laminating two or more glass plates using plastics films. In some embodiments, an outer pane and an inner pane can be connected to one another by an intermediate layer of plastics material. This can provide increased bonding strength and safety, since the glass fragments and shards predominantly adhere to the plastics film in the event of a break. In addition, the laminated glass makes it possible to apply special coatings to the inner surfaces of the glass plates facing the plastics film, wherein the coatings can serve to reflect sunlight and heat the pane.

In some embodiments, the outer pane and the inner pane may correspond to two glass plates that are used in the laminated glass construction, for example for a front window. The outer pane is the outer plate, which is arranged on an outside (of the vehicle) and is thus exposed to environmental influences such as sunlight, wind, and rain. In contrast, the inner pane is the inner plate, which faces an interior (of the vehicle). Both panes are interconnected by an intermediate plastics layer. According to the teachings herein and in some embodiments, special coatings can be applied to the inner surfaces (towards the intermediate plastics layer) of both panes, said coatings each having different functions: The inside of the outer pane receives a reflective coating for reducing the solar irradiation, whereas the inside of the inner pane receives a heating coating that allows for an efficient heating function in the winter.

In some embodiments, the intermediate plastics film may be a component of the laminated glass pane that connects the two glass plates to one another. This film may consist of various plastics materials, wherein polyvinyl butyral (PVB) is often used due to its excellent adhesion to glass and its high transparency. The film may also have UV-absorbing properties in order to reduce damaging ultraviolet rays. The thickness of the film can vary depending on the specific requirements for safety and for the insulation properties of the front window. In some embodiments, the film may also be colored or tinted in order to provide additional sun protection or privacy.

In some embodiments, the reflective coating in the laminated glass pane (front window) is applied to the inside of the outer pane and has the main function of reflecting sunlight, in particular infrared light (for example near-infrared - NIR). The reflective coating may consist of a plurality of layers which are deposited or else applied to the inside of the outer pane using a variety of application methods. Physical vapor deposition (PVD) is an example method that can be used to coat the inside of the outer pane. In this method, thin layers are produced by vaporizing a solid in a vacuum and are then deposited on the inside of the outer pane. Further such application methods comprise CVD (chemical vapor deposition), ALD (atomic layer deposition), sputter coating, or e-beam PVD (electron-beam PVD).

In some embodiments, the reflective coating can be optimized for reflection in a predetermined (preselected) wavelength range of light by the reflections and emissions on the boundary layers of the plurality of layers by means of constructive and destructive interference of the resulting partial beams. By reflecting, for example, the sunlight, the reflective coating reduces the amount of heat that enters the interior of the vehicle on the inside of the laminated glass pane (vehicle interior), as a result of which less heating of the interior can be expected in the summer.

The reflective coating is almost invisible to the human eye, and therefore the view through the pane is not obstructed. In the context of a vehicle, this meets a legal requirement that at least 70% of visible light must be transmitted through the front window. In combination with a heating coating, this can be provided with two silver-containing coatings, but this may no longer be the case with three silver-containing coatings.

In some embodiments, the heating coating in the laminated glass pane (front window) can be applied to the inside of the inner pane and serves to heat the pane if necessary. The coating can convert supplied electrical energy into thermal energy, due to the ohmic resistance of the coating, and thus heats up the laminated glass pane.

In contrast to conventional heating methods, which are based on the circulation of warm air, this coating can allow for direct and uniform heating of the entire pane surface. This can significantly speed up and render more efficient the defrosting and defogging of the pane in the cold months. A high operating voltage of the heating coating can also allow for a reduction in the cable cross-sections, which contributes to simplified and more cost-effective installation.

Due to the fact that the heating coating is designed to be supplied with electrical energy, the heating coating can be designed to absorb electrical current and convert it into heat. This means that the coating is designed such that it can absorb a flow of electrical current when it is connected to a power source. A connection to a power source can, for example, be established by means of electrical contacts on the laminated glass pane. For example, the contacts are designed as busbars which contact the heating coating, for example parallel to a vertical edge of the laminated glass pane, and thus improve the electrical energy distribution in the heating coating (consequently also the thermal energy distribution) and allow for a more homogeneous distribution in order to allow for more homogeneous heating of the laminated glass pane. More homogeneous heating, better transmission optics, and an IR-reflecting heat protection function are improvements compared with an arrangement of heating wires in the front window.

The flow of current can cause resistive heating in the coating, which then heats the pane. The amount of heat generated depends on the amount of electrical work supplied to the coating. Therefore, the heating coating is designed such that it can be operated with a high electrical voltage in order to allow for more efficient heating with lower heat loss. The increased heating capacity due to the high voltage also offers the option of situation-and function-specific heating, e.g. longer in the event of severe frost than in the event of light frost. This means that the heating time can be precisely dosed, which in turn increases the efficiency or else conserves scarce energy resources. In addition, according to the teachings herein, a front window can be heated up faster and more efficiently than known technical solutions.

In some embodiments, the heating with the heating coating can replace the ventilation (with warm air coming out of ventilation slots and air ducts) from the dashboard. Thus, a defrost and defog function of the pane is possible in which ice scraping may no longer be needed. This also frees up space within the dashboard (inside the instrument panel).

This space in the dashboard can be used, for example and in some embodiments, for displays or projectors, for example for head-up displays. For this purpose, further reflection and emission coatings can be provided on the laminated glass pane which allow for a clear image of the head-up displays without visible multiple reflections on multiple boundary layers of the laminated glass pane. In the absence of ventilation slots, projectors can instead be installed which, for example, illuminate a region on the lower edge of the laminated glass pane. This region can also be printed/coated with black paint (on the outside or inside or on an intermediate layer) in some embodiments. This prevents background light from interfering with the appearance of the displays.

The heating coating may be a single layer in some embodiments.

Furthermore, it is possible in some embodiments for reflective coatings and/or heating coatings to not be provided in various regions of the laminated glass pane. For example, no layers are applied in these regions or layers are removed from these regions. For example, this may be so as to not impair the functioning of sensors, cameras, or antennas.

In some embodiments, the reflective coating is formed of single, double, triple, or quadruple silver-containing coatings.

A silver-containing coating is a layer or layer system which contains silver and is applied to a surface. This coating has the property that it effectively reflects sunlight, in particular in the infrared range. This means that a majority of the solar radiation that strikes the surface is reflected back into the environment instead of being converted into heat after being transmitted behind the laminated glass pane. This is particularly beneficial in applications in which the heat transmission is to be reduced, for example in the case of window glass in vehicles or buildings. In spite of its high reflectivity, a silver-containing coating is almost invisible to the human eye, and therefore it does not obstruct the view through the coated glass.

In some embodiments, a single silver layer in the silver-containing coating (reflective coating) may be a very thin layer (with a thickness of a few nanometers) of pure silver that is applied to the glass surface. This may take place, for example, using a method such as PVD. Silver is an excellent reflector of light, in particular light in the infrared range, and can therefore contribute to minimizing the transmission of “thermal radiation” through the pane and thus reduce the heating of the vehicle interior behind the pane.

However, in a multi-layer system, the silver layer may be just one element in a more complex structure. In this case, the silver layer is surrounded by further layers that serve to improve and optimize the optical properties of the coating. These additional layers may consist of various materials and may, for example, serve to enhance the reflective properties of the silver layer or to minimize undesired side effects.

If the silver-containing coating is designed as a double silver layer system and in some embodiments, there are, for example, two layers of pure silver surrounded in each case by other layers. This can improve the reflective properties of the system even further. In the case of a triple or quadruple silver layer system, either three or four silver layers are applied, which can lead to an even higher reflection rate. However, each additional silver layer also increases the complexity and the costs of the coating system, i.e., the reflective coating. The layer system for a single silver coating can, for example, be repeated for a double silver coating. The same applies to a triple or quadruple layer system.

It is beneficial to note that, in spite of the high reflectance of the silver layers, same may in some embodiments be designed such that, taken together, they transmit over 70% of the light wavelength spectrum that is visible to the human eye, since this may be a legal requirement for front and side windows back to the B-pillar.

With a double silver-containing coating, a “Total Transmission Solar” (TTS) value of approx. 50% can be achieved. This value is a measure of the energy input of the sun through the front window and describes the proportion of directly transmitted radiant heat and the proportion of thermal radiation that enters the interior by way of heat absorption by the pane. The lower the value, the better the thermal protection (summer function).

As a general rule, the higher the number of Ag layers (1, 2, 3, 4. . . ), the lower the specific layer resistance and thus overall connection resistance of the front window may be. Single, double, triple, or quadruple silver-containing coatings generally have low connection resistances (low impedance). Thus, these layers are less well suited for generating thermal energy from electrical energy than layers having higher resistances. At the same, low voltage (12V), increasing the number of layers makes it possible to increase the heating capacity, but this may be limited by the legally prescribed light transmission. Furthermore, this may also require additional production steps.

By separating the summer function (via infrared-reflecting silver layers) and winter function (via high-impedance heating layers) in a laminated glass pane by applying various boundary surfaces within the structure, both functions can be optimally performed. While the double or triple design of the silver layers on the inside of the outer sheet of glass ensures the lowest possible TTS value, the high-impedance layer on the outside of the inner sheet of glass, which outside is untouchable in the assembled state, in combination with a significantly higher electrical voltage creates a much higher thermal capacity than is known from previous applications.

An additional voltage converter may be beneficial for this purpose.

In some embodiments, the reflective coating is a dielectric mirror layer which is designed to primarily reflect infrared light.

A dielectric mirror layer is a coating which consists of multiple dielectric layers lying one on top of the other and has the property of reflecting light waves of particular wavelengths. Said layers may consist of various materials and are thus coordinated with one another such that they allow light waves of particular wavelengths to interfere constructively, which leads to increased reflection. In the teachings herein, the dielectric mirror layer is designed such that it primarily reflects infrared light. Infrared light is thermal radiation, and therefore the reflection thereof reduces the heat input through the laminated glass pane (into the vehicle and improves driving comfort in the summer). In spite of its high reflectivity, the dielectric mirror layer is almost invisible to the human eye. Silver layers can be part of the dielectric mirror layer.

A dielectric mirror may be designed such that a reflectance of the dielectric mirror has a plateau in one wavelength range (for example infrared radiation), but in other wavelength ranges (for example visible light) is low and thus allows for good transmission.

In some embodiments, the heating coating comprises a high-impedance material.

A high-impedance material may be a material which has a high electrical resistance. This means that it impedes the flow of electrical current through the material. When applied in the heating coating in the laminated glass pane (front window) according to the design, the high-impedance material can contribute to generating a higher heating capacity by efficiently converting the supplied electrical energy into thermal energy. Since the coating is applied evenly, the heat generation is also homogeneously distributed over the pane. This allows for fast and uniform heating of the entire pane surface.

High-impedance materials can comprise a plurality of materials, including metals, metal oxides, semiconductors and, if applicable, also insulators, for example ceramics. The high-impedance material may be applied as a layer that is transparent in the visible spectrum, i.e., it is possible to see through it.

The high operating voltage made possible by the high-impedance material can result in a more efficient heating function in some embodiments, since it makes it possible to supply a higher electrical energy than a material having a lower resistance, taking into account availabilities of possible transparent functional layers, heat-up rate, lower current flow, and thus smaller cable cross-sections. The electrical energy can be converted efficiently into thermal energy on account of the high resistance, which yields improved heating. This can result in faster and more efficient defrosting and defogging of the pane. In addition, the technical effort for the voltage conversion is lower on account of the high operating voltage.

In some embodiments, the heating coating is an ITO, ZNO:Al, or FTO layer.

ITO (indium tin oxide), ZNO:Al (aluminum-doped zinc oxide), and FTO (fluorine-doped tin oxide) are materials which can be used as heating coatings on account of their properties. ITO, ZNO:Al, and FTO are metal oxides with high-impedance properties, which means that they have a high electrical resistance. This makes it possible for them to generate an efficient heating capacity in that they efficiently convert the supplied electrical energy into heat.

The ITO layer is a thin, semiconductive coating that consists of indium tin oxide. It is transparent in the visible spectrum and has the property of reflecting infrared light well.

The ZNO:Al layer is a transparent oxide semiconductor layer that consists of aluminum-doped zinc oxide, which is a transparent, electrically conductive but high-impedance oxide.

The FTO layer is another type of high-impedance heating coating which consists of fluorine-doped tin oxide. Like ITO, FTO is transparent in the visible spectrum. This makes FTO a suitable material for heating coatings in laminated glass panes as well.

The materials ITO, ZNO:Al, and FTO can be applied using various techniques to the inside of the inner pane, for example sputtering or as slurry/gel spraying. Their high operating voltage allows for an efficient heating function and requires a smaller cable cross-section.

ITO, ZNO:Al, and FTO can, for example, be energized with 200-400 V. With a heating coating of this kind, a heating capacity of, for example, 11 kW is possible instead of the typical 0.5 kW, for example, which corresponds to a heating capacity that is 22 times higher than before, as a result of which higher thermal energy can be generated. Otherwise, it can be typical to heat a pane with 12-48 V. Furthermore, ITO, ZNO:Al, or FTO reflects only little (these materials have a reflectance of approx. 3%).

In some embodiments, the laminated glass pane is a windscreen for a vehicle.

The windscreen, also referred to as the front window, can be an component of a vehicle and can serve to protect the interior of the vehicle from wind, rain, and other environmental influences while simultaneously allowing for a clear view onto the road. The windscreen is typically manufactured from laminated glass and consists of an outer pane and an inner pane, which are interconnected by an intermediate plastics layer. The outer pane is the outer glass plate, which is arranged on the outside of the vehicle is thus exposed to environmental influences such as sunlight, wind, and rain. In contrast, the inner pane is the inner glass plate, which faces the interior of the vehicle.

The windscreen according to the teachings herein may in some embodiments be equipped with a combination of coatings that allows for effective reflection of sunlight in order to reduce the interior heating in the summer as well as for an efficient heating function for fast and efficient defrosting and defogging of the pane in the winter.

A controller (also referred to herein as a ‘control circuit’) according to the teachings herein is designed to control the heating coating of the laminated glass pane, such that the electrical energy supplied to the heating coating can be adapted to ambient conditions.

The controller in the context of the present discussion may be an electronic device or system that serves to control the operating parameters or functions of other devices or systems in an open-loop or closed-loop manner. In this case, the controller according to the design is designed to control the heating coating of a laminated glass pane in an open-loop manner. To this end, the controller can regulate and adapt the amount of electrical energy supplied to the heating coating. This regulation and adaptation can take place based on various parameters or ambient conditions.

Originally, the heating of the pane mostly worked via a pre-set timer and the operating switch that starts the heating. In contrast, the electrical energy or else the heating time can be adapted by means of the controller based on ambient conditions.

The electrical energy supplied to the heating coating can, for example, be controlled in an open-loop manner by the controller in that the amount of electrical energy supplied to the heating coating is regulated. This may take place, for example, by controlling the voltage or the current supplied to the heating coating from a power source. The power source may be a battery or a generator. The controller may be configured to automatically adapt the electrical energy, for example based on the current ambient conditions or based on inputs from a user.

The ambient conditions may include various factors or parameters that can influence the operating conditions or requirements for the heating coating. Examples of such ambient conditions may be the outside temperature, the inside temperature of the vehicle, the humidity, or the solar irradiation. The controller can obtain information about the current ambient conditions from various sensors or input devices that may be arranged in or around the vehicle.

Furthermore, the controller can retrieve this information from a network via an interface. Such a network may be a wireless local area network (WLAN) which may be based, for example, on the IEEE 802.11 standard and may be used in home networks, offices, and public areas. Another possibility for the network is a wireless personal area network (WPAN), for example Bluetooth, wireless USB, ZigBee, and Z-Wave. Furthermore, the network may also be a wireless wide area network (WWAN), for example mobile communication technologies such as LTE and 5G. A network such as a wireless metropolitan area network (WMAN) is also possible. Further possibilities for the network include a wireless sensor network (WSN), for example networks consisting of distributed sensors that record environment data and transmit same wirelessly. They are often used within the scope of the Internet of Things (IoT). A satellite network is another possible network, which uses satellites for global communication and data transmission, in particular in remote areas. Furthermore, a wireless mesh network is another option, in which the devices themselves serve as a router and forward data.

Based on this information, the controller can then accordingly adapt the electrical energy supplied to the heating coating in order to provide an efficient heating function for fast and efficient defrosting and defogging of the pane in the winter.

The controller can control the electrical energy based on the information and a corresponding (predetermined) characteristic map. Furthermore, sensors could also be used to monitor the heating process and to generate a feedback signal which can be used to control the heating in a closed-loop manner. However, more sensors are required for this.

Furthermore, the heating coating may be controlled in an open-loop manner via the controller by means of pulse width modeling. The pulse width modeling may be dependent on the outside temperature and the speed.

Furthermore, switch cooling may be used if the pulse width modeling switches become warm. Moreover, the pulse width modeling may be configured such that steep flanks are prevented so that the switches do not become warm.

Furthermore, low-frequency switching signals (e.g. less than 100 Hz) may be used. A controller for a continuously applied voltage, for example a dimmer, is also possible.

The disclosure also relates to a vehicle comprising a laminated glass pane according to the teachings herein.

The vehicle of the teachings herein may be a car, a truck, a bus, a train, an all-terrain vehicle, an agricultural vehicle, a construction vehicle, an airplane, a ship, a boat, or any other vehicle that requires a front window. It may be a conventionally driven vehicle or an electric vehicle.

The front window of the vehicle is designed according to any embodiments discussed herein. A reflective coating that primarily reflects infrared light and thus reduces the heating of the vehicle interior in the summer is applied to the inside of the outer pane. A heating coating that allows for an efficient heating function in the winter is located on the outside of the inner pane.

Due to this combination of reflective and heating coating, the front window of the vehicle can have optimal properties both in the summer and in the winter. In the summer, the heating of the vehicle interior is reduced by the reflection of sunlight, whereas in the winter, fast and efficient defrosting and defogging of the pane is possible.

In some embodiments, the vehicle as discussed herein further comprise the controller according to any of the embodiments discussed herein.

The controller in the vehicle can be designed to control the heating coating of the front window in an open-loop manner. It can regulate and adapt the amount of electrical energy supplied to the heating coating. This can take place based on various parameters or ambient conditions, for example the outside temperature, the inside temperature of the vehicle, the humidity, or the solar irradiation.

The controller can obtain information about the current ambient conditions from various sensors or input devices that may be arranged in or around the vehicle. Based on this information, the controller can then accordingly adapt the electrical energy supplied to the heating coating in order to provide an efficient heating function for fast and efficient defrosting and defogging of the pane in the winter. The electrical energy supplied to the heating coating can be provided by a power source such as a battery or a generator and be controlled in an open-loop or closed-loop manner by the controller

The controller may be configured to automatically adapt the electrical energy, for example based on the current ambient conditions or based on inputs from a user. It may, for example, have an interface to a network via which it can retrieve current environment data or be operated via said interface.

By integrating the controller in the vehicle, the front window can be optimally utilized and the energy available in the vehicle can be utilized better. Efficient defrosting and defogging also improve the efficiency of the vehicle.

Reference will now be made to the drawings in which the various elements of embodiments will be given numerical designations and in which further embodiments will be discussed.

In the embodiments described herein, the described components of the embodiments each represent individual features that are to be considered independent of one another, in the combination as shown or described, and in combinations other than shown or described. In addition, the described embodiments can also be supplemented by features other than those described.

Specific references to components, process steps, and other elements are not intended to be limiting. Further, it is understood that like parts bear the same or similar reference numerals when referring to alternate FIGS.

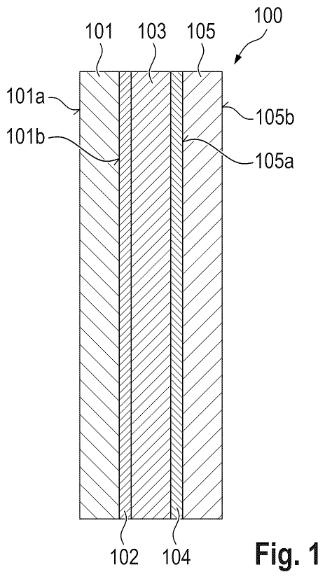

FIG. 1 shows a cross-section through a laminated glass pane 100 according to one example embodiment.

The laminated glass pane 100 comprises an outer pane 101, a reflective coating 102, a PVB film 103, a heating coating 104, and an inner pane 105. In this sequence, a light beam would travel from the outside inwards (into a vehicle having the laminated glass pane 100).

The outer pane 101 is the first glass layer of the laminated glass pane 100. The first side 101a is the outside of the outer pane 101 of the laminated glass pane 100 and faces the outside world. It is exposed to environmental influences such as wind, rain, and sunlight. A double silver layer (Ag2) is applied to the second side 101b. This layer serves as a reflective coating 102 and primarily reflects infrared light in order to reduce the heating of the vehicle interior in the summer. The second side 101b is the side of the outer pane 101 facing the PVB film 103.

The PVB film 103 is arranged between the two glass layers. The polyvinyl butyral (PVB) film connects the two glass layers to one another and increases the safety of the pane 100, since it retains the shards in the event of a break.

The inner pane 105 is the inner glass layer of the laminated glass pane 100 and faces the interior of the vehicle. A coating made of fluorine-doped tin oxide (FTO), aluminum-doped zinc oxide (ZNO:Al), or indium tin oxide (ITO) is applied to the third side 105a. This layer serves as a heating coating 104 and can heat the pane 100 by means of a supply of electrical energy. The third side 105a is the side of the inner pane 105 facing the PVB film 103. The fourth side 105b is the inside of the laminated glass pane 100 and faces the interior of the vehicle.

The combination of a reflective coating 102 and heating coating 104 makes it possible to optimally utilize the laminated glass pane 100 both in the summer and in the winter. In the summer, the heating of the vehicle interior is reduced by the reflection of sunlight, whereas in the winter, fast and efficient defrosting and defogging of the pane 100 is possible by means of the heating function.

It may be disadvantageous to swap the positions of the reflective coating 102 and heating coating 104, since moisture would enter in the event of a stone impact and would then make contact with an energized/conductive heating coating 104. However, in this case, it would take some time for the reflective coating 102 to become discolored.

Alternatively, only a laminated glass pane 100 having a reflective coating 102 and no heating coating 104 may be provided. Then, an additional voltage converter is used, for example, for 48 V if the on-board power supply does not already provide 48 V.

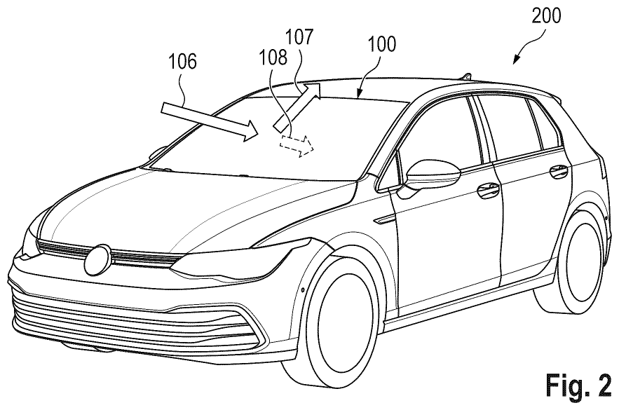

FIG. 2 shows a vehicle 200 having a laminated glass pane 100 according to one exemplary embodiment.

The vehicle 200 comprises a laminated glass pane 100 of the like described in FIG. 1. FIG. 2 shows irradiation 106, transmission 108, and reflection 107. The irradiation 106 represents all the solar radiation that strikes the laminated glass pane 100. Some of this radiation is reflected by the reflective coating 102 and emitted back into the surroundings. Some of the radiation is transmitted through the laminated glass pane 100. The transmission 108 is converted into heat on surfaces inside the vehicle 200 and thus heats up the interior of the vehicle 200. In this case, the transmission 108 is also referred to as the Total Transmission Solar. In this exemplary embodiment, the transmission 108 contributes, for example, approx. 48% of the solar irradiation 106, the rest being reflected or absorbed in the laminated glass pane 100.

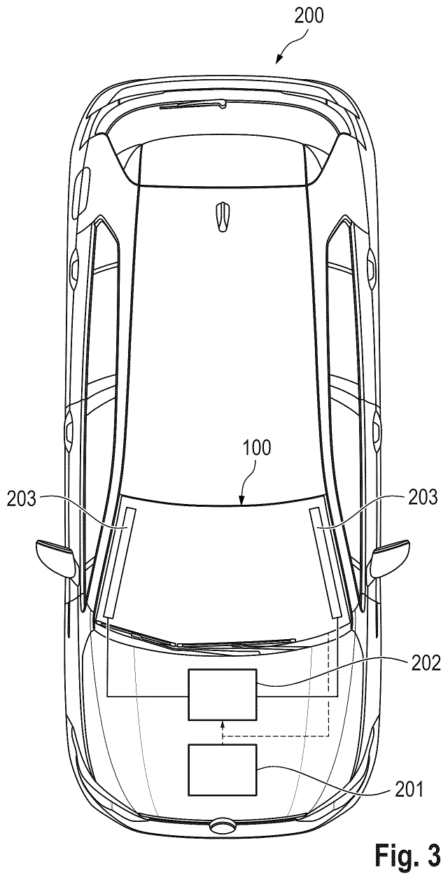

FIG. 3 shows a vehicle 200 having a laminated glass pane 100, a controller 201, and a power source 202 according to one exemplary embodiment.

The vehicle 200 comprises a laminated glass pane 100, a power source 202, and a controller 201.

The laminated glass pane 100 is the laminated glass pane described in FIG. 1. The power source 202 supplies the heating coating 104 of the laminated glass pane 100 with electrical energy. This is shown by the connection to the bottom left and right corner of the laminated glass pane 100. There, the heating coating 104 of the laminated glass pane 100 is contacted, for example by means of busbars 203 which extend on the left and right along an edge of the laminated glass pane 100 (for example below a black imprint on the laminated glass pane 100). Said power source 202 may be a battery or a generator that is integrated in the vehicle 200. The battery may be a conventional car battery or a high-power battery of the like used in electric vehicles. The generator may be part of the engine of the vehicle 200 and generate electrical energy by converting mechanical energy. The power source 202 delivers the electrical energy, which is converted into heat by the heating coating 104 in order to heat the pane 100. The amount of electrical energy supplied to the heating coating 104 can be regulated by the controller 201 in order to ensure an efficient heating function.

The controller 201 is an electronic device or system that serves to control the operating parameters or functions of other devices or systems in an open-loop or closed-loop manner. In this case, the controller 201 is designed to control the heating coating 104 of a laminated glass pane 100 in an open-loop manner. This is illustrated by the connections to the power source 202 and to the laminated glass pane 100. Therefore, either the power source 202 directly or a switching or else dimming mechanism in the laminated glass pane 100 can be controlled in an open-loop manner. Furthermore, a switching or else dimming mechanism installed at another location in the vehicle 200, for example in the controller 201, could be used. It can regulate or adapt the amount of electrical energy supplied to the heating coating 104. This can take place based on various parameters or ambient conditions, for example the outside temperature, the inside temperature of the vehicle 200, the humidity, or the solar irradiation 106. The controller 201 can obtain information about the current ambient conditions from various sensors or input devices that may be arranged in or around the vehicle 200. Based on this information, the controller 201 can then accordingly adapt the electrical energy supplied to the heating coating 104 in order to provide an efficient heating function for fast and efficient defrosting and defogging of the pane 100 in the winter.

### LIST OF REFERENCE NUMERALS

100 Laminated glass pane
101 Outer pane
101a First side
101b Second side
102 Reflective coating
103 PVB film
104 Heating coating
105 Inner pane
105a Third side
105b Fourth side
106 Irradiation
107 Reflection
108 Transmission
200 Vehicle
201 Controller
202 Power source

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A laminated glass pane, comprising an outer pane, an inner pane, and an intermediate plastics film which is arranged between the outer pane and the inner pane, further comprising: a reflective coating that is applied to a side of the outer pane that is facing the intermediate plastics layer, and a heating coating that is applied to a side of the inner pane that is facing the intermediate plastics layer, wherein the heating coating is configured to be supplied with electrical energy at a voltage of 200 V to 800 V in order to heat the laminated glass pane.

2. The laminated glass pane of claim 1, wherein the reflective coating is formed of single, double, triple, or quadruple silver-containing coatings.

3. The laminated glass pane of claim 1, wherein the reflective coating is a dielectric mirror layer which is configured to primarily reflect infrared light.

4. The laminated glass pane of claim 1, wherein the heating coating comprises a high-impedance material.

5. The laminated glass pane of claim 1, wherein the heating coating comprises ITO, ZNO:Al, or FTO.

6. The laminated glass pane of claim 5, wherein the heating coating comprises an ITO, ZNO:Al, or FTO layer.

7. The laminated glass pane of claim 1, wherein the laminated glass pane is a windscreen for a vehicle.

8. A controller configured to control the heating coating of a laminated glass pane of claim 1 such that the electrical energy supplied to the heating coating can be adapted to ambient conditions.

9. A vehicle, comprising a laminated glass pane, comprising an outer pane, an inner pane, and an intermediate plastics film which is arranged between the outer pane and the inner pane, further comprising: a reflective coating that is applied to a side of the outer pane that is facing the intermediate plastics layer, and a heating coating that is applied to a side of the inner pane that is facing the intermediate plastics layer, wherein the heating coating is configured to be supplied with electrical energy at a voltage of 200 V to 800 V in order to heat the laminated glass pane.

10. The vehicle of claim 9, further comprising a controller, configured to control the heating coating of the laminated glass pane such that the electrical energy supplied to the heating coating can be adapted to ambient conditions.

11. The vehicle of claim 9, wherein the reflective coating is formed of single, double, triple, or quadruple silver-containing coatings.

12. The vehicle of claim 9, wherein the reflective coating is a dielectric mirror layer which is configured to primarily reflect infrared light.

13. The vehicle of claim 9, wherein the heating coating comprises a high-impedance material.

14. The vehicle of claim 9, wherein the heating coating comprises ITO, ZNO:Al, or FTO.

15. The vehicle of claim 15, wherein the heating coating comprises an ITO, ZNO:Al, or FTO layer.

16. The vehicle of claim 9, wherein the laminated glass pane is a windscreen for a vehicle.
